(19) United States
(12) Patent Application Publication
(10) Pub. No.: US 2024/0275155 A1
(43) Pub. Date: Aug. 15, 2024

(54) Cable Channel

(71) Applicant: Oxford Direct Services Trading Limited, Oxford (GB)

(72) Inventors: Shaun HATTON, Oxford (GB); Jason MUNRO, Oxford (GB); Sophie HEARN, Oxford (GB); Andrew WHITTINGTON, Oxford (GB)

(21) Appl. No.: 18/566,910

(22) PCT Filed: Jun. 1, 2022
(86) PCT No.: PCT/GB2022/051403

§ 371 Date: Dec. 4, 2023

(30) Foreign Application Priority Data
Jun. 3, 2021 (GB) 2107958.7

(51) Int. Cl. H02G 9/06; H02G 1/08

(52) U.S. Cl. CPC H02G 9/065; H02G 1/08

(57) ABSTRACT

A channel comprising an elongate slot for receiving a length of a flexible conduit. The slot comprises an opening extending along its length for laying a flexible conduit into the slot and for removing the flexible conduit therefrom and a barrier which is biased to block at least part of the opening in the absence of an externally applied force.

### FIELD

Embodiments described herein relate to channels for removably receiving flexible conduits such as charging cables for electric vehicles, methods of embedding such channels in surfaces, and to arrangements comprising such embedded channels.

### BACKGROUND

Electric vehicles are typically charged using cables extending to the vehicle from a power source such as a dedicated vehicle charging station or an electrical outlet. As the space between such a power source and the vehicle being charged is often traversed by humans, such a charging cable can present an obstacle or trip hazard.

This problem is particularly apparent when cables are used to charge vehicles parked at the side of a road using a power source within an adjacent building or property on the opposite side of a pavement or sidewalk from the parked vehicle. This requires the cable to extend across the pavement or sidewalk where it presents a trip hazard to pedestrians walking along the pavement or sidewalk, risking injuries to such pedestrian or damage to the cable.

European patent application EP18759666.3 relates to a segmented duct which defines a continuous passage for an electric vehicle charging cable.

An aim of the present invention is to provide arrangements for preventing electric vehicle charging cables and other flexible conduits from presenting such hazards.

### STATEMENTS OF INVENTION

According to a first aspect of the invention there is provided a channel comprising an elongate slot for receiving a length of a flexible conduit, wherein the slot comprises an opening extending along its length for laying a flexible conduit into the slot and for removing the flexible conduit therefrom and a barrier which is biased to block at least part of the opening in the absence of an externally applied force.

In use the channel may be formed or embedded in a surface, for example, an outdoor ground surface such as a pavement, sidewalk or road surface, and when a flexible conduit, such as an electric cable (e.g. an electric vehicle charging cable) or a hollow conduit for fluids, is required to extend across the surface it may be laid within the channel such that it does not present an obstacle or trip hazard over the surface. When use of the flexible conduit is complete it may be conveniently removed from the channel via the lengthwise opening.

The channel comprising an opening extending along its length advantageously facilitates temporarily laying and subsequently removing a flexible conduit within the slot; especially in comparison to existing cable channels, which require the cable to be fed lengthwise into and out of the channels via ends thereof. The opening therefore makes it easier for a user to only place a charging cable within the channel when it is in use. This is particularly advantageous when the channel is embedded in a public pavement or sidewalk extending between a private property and kerb-side parking adjacent thereto.

The barrier may be biased towards blocking or sealing at least part of the opening of the slot, which advantageously prevents or limits debris or water from entering the slot through that part of the opening. In preferred embodiments, the barrier is configured to allow a flexible conduit to be forced past the barrier, preferably in both directions, into and out of the slot. For example, the barrier may be arranged to deflect into and out of the opening of the slot, so as to allow a flexible conduit to be pushed past the barrier in both directions. The barrier may be displaceable and/or deformable.

In some embodiments, the barrier may be a resiliently deformable seal. In such embodiments, the resiliently deformable seal is a brush seal.

In some embodiments, the barrier may be biased towards blocking the majority of the length of the opening of the slot.

In some embodiments, the channel may be formed in an elongate body for embedding in ground surface. Such a body may comprises one or more laterally protruding tabs. The body may comprise a longitudinal axis along which the slot may extend.

In such embodiments, the slot extends to at least one end of the elongate body and an end of the slot is open at said end of the body.

In some embodiments, the opening of the slot is formed in a surface of the body which is a non-slip surface.

In some embodiments, the body comprises one or more hollow cavities (for example, two hollow cavities on either side of the slot), each with a wall defining a sidewall of the slot.

According to a second aspect of the invention, there is provided an arrangement comprising a channel as described above embedded within a ground surface.

In some embodiments, the ground surface may be a pavement or sidewalk. In some such embodiments, a longitudinal end of the body of the channel may be flush with a kerb of the pavement or sidewalk or with an indent formed in such a kerb.

In some embodiments, the slot comprises a base, which slopes from one end to another.

According to a third aspect of the invention, there is provided a method of constructing an arrangement as described above, the method comprising embedding a channel as described above within the ground surface.

In some embodiments, the method may comprise embedding the channel within the ground surface within or on a concrete haunch.

Embodiments of the invention will be described by way of example and with reference to the following figures.

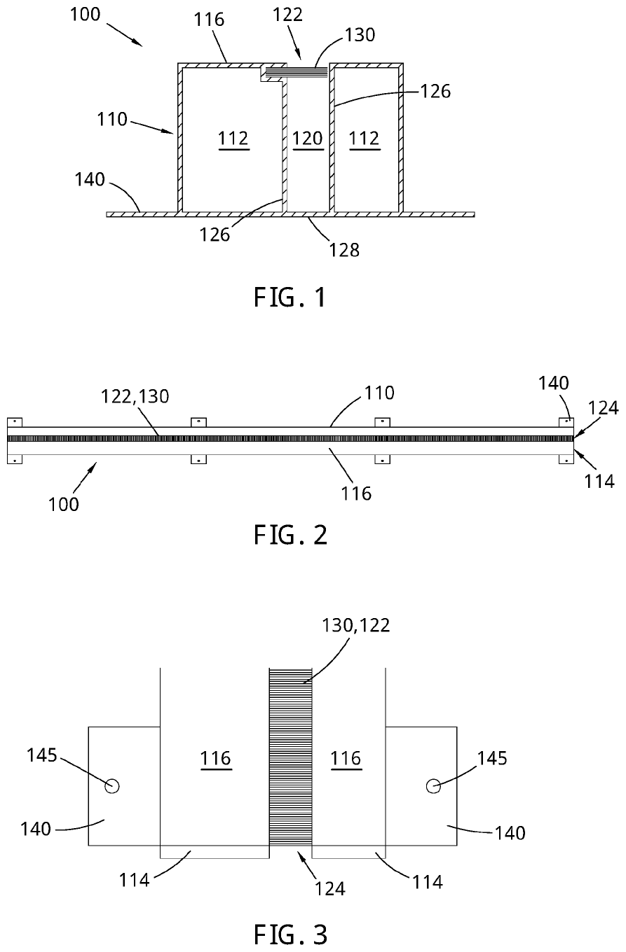

FIG. 1 shows a cross-sectional view of a channel for an electric vehicle charging cable;

FIG. 2 shows a top-down view of the channel of FIG. 1;

FIG. 3 shows a detailed top-down view of an end of the channel of FIG. 1;

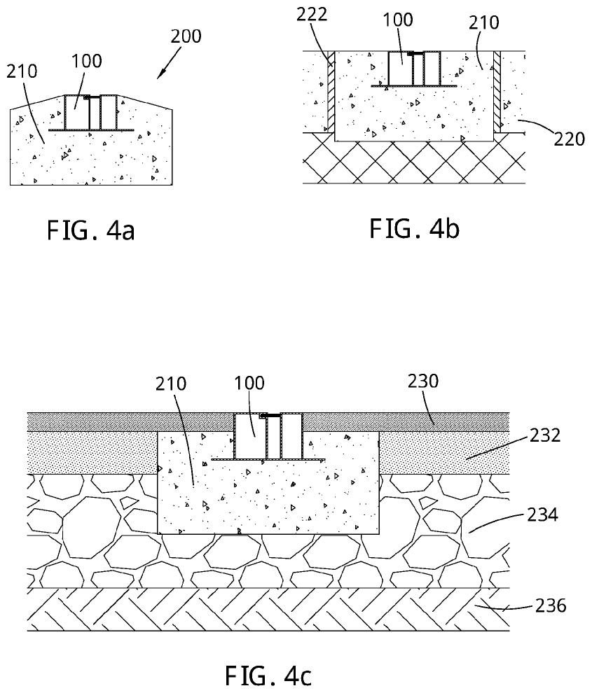

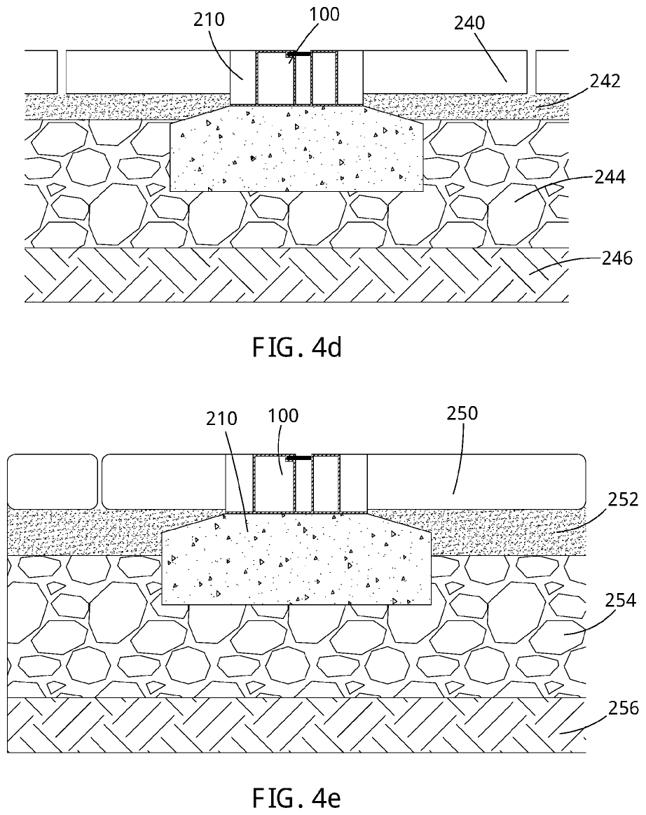

FIGS. 4a to 4d show cross-sectional views of the channel of FIG. 1 embedded in different surfaces; and

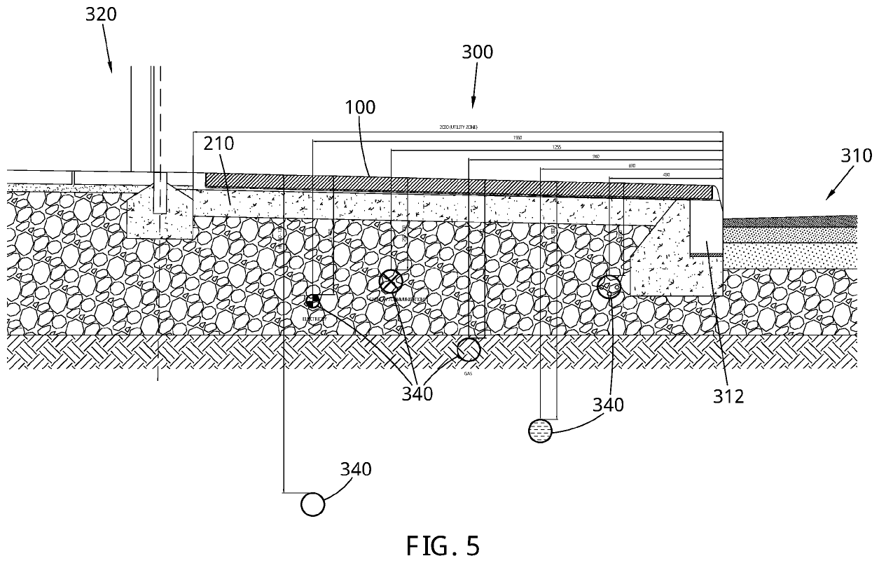

FIG. 5 shows a cross-sectional side-on view of the channel of FIG. 1 embedded in a pavement surface.

### DETAILED DESCRIPTION

FIGS. 1, 2 and 3 show cross-sectional, top down, and detailed end views of a channel 100 for an electric vehicle charging cable respectively.

The channel 100 is defined by an elongate rectangular-cuboid-shaped cast steel body 110. The cast steel body 110 provides impact resistance, and load bearing capabilities to the channel, which in use will be embedded in surfaces such as pavements, sidewalks or roadways, over which vehicles may drive occasionally or frequently. For example, delivery vehicles may drive onto or over a pavement embedded channel when loading or unloading, and resident's cars may drive onto or over such a channel when parking. It will be appreciated that the channel body may be formed of other suitable metals or materials or using other suitable techniques, for example depending upon the intended location in which the channel is to be used.

An elongate slot 120 is formed in the body 110 extending parallel to its length with an elongate opening 122 extending along its length. The opening 122 of the slot 120 is unbroken along its length, allowing a cable to be laid into the slot 120 or removed therefrom without requiring it to be threaded through any enclosed portions of the slot 120. The elongate opening 122 of the slot 120 is formed in a surface 116 of the body 110 which is arranged facing upwards in use.

In the illustrated channel 100, the slot 120 extends along the full length of the body 110 between opposite ends thereof, however it will be appreciated that in alternative embodiments, the slot 120 may extend along only part of the length of the body 110. The slot 120 preferably extends to at least one end of the body 110.

In the illustrated channel 100, the slot 120 is open at both of its ends 124 so that it readily allows a cable laid in the channel to emerge from the channel 120 in its longitudinal direction at the open end 124 or open ends 124 of the slot. It will be appreciated that this may not be the case in alternative embodiments, but that in preferred embodiments, the slot 120 extends to at least one end of the body 110 and is open at this end 124. In use, this end may arranged flush with an edge of a surface in which the channel is embedded (such as with a kerb of a pavement or sidewalk) or an indent therein. This may advantageously allow a cable within the slot 120 to extend out of a side of the surface and may allow water within the slot to drain out of such a side, for example into a gutter adjacent a kerb or indent therein flush with which the ends of the body 110 and the slot 120 are embedded.

The slot 120 comprises two sidewalls 126 extending parallel to its length. These sidewalls 126 are flush to edges of the elongate opening, such that the entire upper edge of the slot 120 is only blocked by the brush seal 130, without any lip or rim which might cause a charging cable or debris from becoming stuck within the slot 120. In the illustrated channel 110, the sidewalls 126 are perpendicular to the surface of the body 110 in which the opening 122 of the slot 120 is formed. However, it will be appreciated that in alternative embodiments, they may be arranged at a different angles, for example to provide a slot 120 which narrows with depth.

The slot 120 comprises a base 128, which in the illustrated channel 100 is defined by the base of the body 110 of the channel 100, and is parallel to the upper surface 116 of the body 110 of the channel 100. It will be appreciated that in alternative embodiments, the base 128 of the slot may be sloped along its length with respect to the upper surface 116, for example in channels intended to be embedded in flat surfaces. This may advantageously allow water in the channel to drain out of an end 124 of the slot 120 even if the channel 100 is not itself at an angle.

The illustrated body 110 of the channel 100 comprises two hollow rectangular-cuboid-shaped cavities 112 defined on either side of the slot 120 extending along the full length of the body 110 parallel to the slot 120. These cavities 112 may provide strength and/or rigidity to the body 110, but will be appreciated that may not be present in alternative embodiments. The ends of the cavities 112 may be sealed at the ends to prevent ingress of water or material thereto. In the illustrated channel 110 the ends of the cavities 112 are sealed using plastic end caps 114.

The channel further comprises a brush seal 130 arranged to deformably block the opening 122 of the slot 120 along its entire length. The brush seal 130 advantageously prevents or limits the ingress of light debris or water into the slot 120 without significantly impeding insertion or removal of an electric vehicle charging cable into the slot 120. For example, a cable within the slot 120 will be able to be conveniently removed from the slot 120 by pulling or lifting an end thereof, such that the cable displaces the brush seal 130 as it is removed, with the brush seal 130 returning to its blocking positon after the cable is pulled therethrough. In some situations the brush seal 130 may support a portion of a cable where it enters or exits the slot 120 through the opening thereof.

The brush seal 130 extends from one of the sidewalls 126 of the slot 120 adjacent the opening. In alternative embodiments, the brush seal may comprise a pair brush portions respectively extending from opposite sidewalls 126 of the slot 120 to meet or interleave towards the centre of the opening 122.

It will be appreciated that in alternative embodiments, the brush seal 130 may be replaced by another barrier that is biased towards blocking or sealing the opening. In some embodiments, the barrier may be or may comprise a resiliently deformable means, such as one or more brush seals as described above, and/or one or more resiliently deformable lips, which may be formed of an elastomer material. In other embodiments, the barrier may be or may comprise other suitable displaceable means for blocking the opening such as one or more displaceable rigid or semi-rigid covers, lids, lips, or flaps biased towards blocking the opening, for example using a spring or other resiliently deformable means.

In the illustrated channel 100 the brush seal 130 is arranged to block the opening along its entire length. It will be appreciated that in alternative embodiments, the brush seal 130 or alternative barrier may only be arranged to block a portion of the length of the opening 122, for example a majority of the opening 122.

In some embodiments, the brush 130 or alternative barrier may be replaceable, for example, to replace or repair it when it becomes excessively worn or otherwise requires maintenance. The barrier is preferably not removed from the channel in normal use and is preferably arranged to allow a flexible conduit to be laid into or removed from the slot 120 past the barrier without the barrier being removed from the channel or slot thereof. For example, the barrier is preferably arranged to deflect such that a flexible conduit can be pushed past the barrier, preferably in both directions (into and out of the slot 120).

The channel 100 further comprises a plurality of tabs 140 projecting from the body 110 for ensuring the channel 100 is retained within a surface in which it is embedded. In the illustrated channel 100 the tabs are formed integrally with the cast metal body 110 and are aligned with and parallel with a surface of the body 110 opposite the surface 116 in which the opening 122 of the slot is formed (which defines the base of the channel 100 in use). In use, these tabs 140 project sideways from the channel 110 into a surface in which the channel is embedded, for example into a concrete haunch. The illustrated channel 100 comprises four pairs of tabs 140 projecting from opposite sides of the body 110 at regular intervals along its length.

Each of the tabs 140 comprises an aperture 145 therethrough for receiving fasteners such as bolts. If the channel 100 is arranged in or on an existing surface or body in use (such as in situations in which the channel is arranged in a surface on top of an existing concrete layer), fasteners may be arranged extending through the apertures 145 into the existing surface or body in order to more securely fix the channel 100.

The surface 116 of the body in which the opening 122 of the slot 120 is formed is preferably arranged flush with surface in which the channel 100 is embedded in use. This surface may therefore define part of a surface on which pedestrians walk in use (such as a surface of a pavement or sidewalk). This surface 116 is therefore preferably non-slip. For example, the surface 116 may comprise a non-slip pattern, such as an embossed non-slip pattern (such as a diamond plate or checker plate pattern), and/or may be coated with a non-slip material (such as non-slip tape).

The illustrated channel 100 is formed of a body 110 of height 65 mm, width 95 mm, and length 1910 mm, formed from 2 mm thick metal. The slot 120 has a width of 18 mm and a depth of 63 mm, with the brush seal extending between a depth of 2 mm and 6 mm into the slot. The width of the body 110 on the side of the slot 120 from which the bristles extend is 46 mm and is 31 mm on the opposite side. The tabs 140 are 30 mm wide, 50 mm deep, 2 mm thick, and are arranged at 620 mm intervals along the length of the channel 100. It will be appreciated that these dimensions may be varied to satisfy specific use cases or regulatory requirements. For example, the length of the channel 100 may be adjusted to correspond to the width of a pavement or sidewalk that the channel is intended to span.

In the illustrated embodiment of a channel 100, the body 110, slot 120, and tabs 140 of the channel 100 are formed as single unitary body, which may facilitate the embedding of the channel within a surface.

In alternative embodiments, the slot 120 of the channel 100 may be formed directly in a surface such as a pavement, sidewalk or roadway, rather than being formed in standalone body 110 which may be embedded in such a surface in use. For example, an elongate slot may be formed in such a surface with an elongate opening extending along its length and a barrier, such as a brush seal or alternative as described above, may be arranged to block or seal all or part of the length of the slot. For example, such a barrier may be comprised or supported by a plate or other supporting means which is fitted into and/or over the elongate opening of the slot formed directly in the surface. For example, a plate may comprise an elongate opening corresponding to and fitted over the opening of the slot, which is at least partially blocked or sealed by a brush seal as described above.

FIGS. 4a to 4e show cross-sectional views of the channel 100 embedded within different surfaces.

In each surface, the channel 100 is embedded within a concrete haunch or haunching 210, which may be formed within an excavated cavity. The tabs 140 of the channel 100 extend into the haunching to retain the channel 100 therein. FIG. 4a shows a channel embedded within such a haunching 210 without showing an external surface in which the haunching 210 is formed. The haunch 210 extends laterally to either side of the channel 100 and downwards below the base of the channel 100. In the illustrated examples, the haunches 210 extend to a minimum distance of 50 mm to either side of the tabs 140 of the channel 100 and to a minimum depth of 100 mm below the channel 100.

Installing the channel 100 in a surface, such as a pavement may comprise: performing a utility survey to identify any subsurface utilities (such as pipes or electrical channels) running beneath the pavement at the intended location of the channel 100; removing any surface courses such as block or slab paving, and potentially setting such removed courses aside for subsequent relaying; excavating a sub-base volume necessary to provide a sufficiently wide concrete haunch to support the channel 100; forming a notch or indent in a kerb of the pavement such that it can lie flush with an end of the channel if necessary, setting the channel 100 within a concrete haunching within the excavated area; and/or relaying a surface around the embedded channel, preferably to match the surrounding and/or excavated surface.

The channel 100 may be embedded in a surface such that its upper surface 116 is flush with the surface in which it is embedded. The channel may therefore have a gradient corresponding to that of the surface in which it is embedded. In preferred embodiments, the channel is embedded in a surface at a non-horizontal gradient with an open end 124 of the slot 120 at its lower end, such that water is able to drain out of the slot 120, for example into a gutter located at an end of the channel 100.

FIG. 4b shows the channel 100 embedded within a concrete slab surface 220. The concrete haunch 210 is arranged within a cavity in the concrete slab surface 220, surrounded by concrete expansion joints 222, which allows the concrete 210, 220 to expand and contract with temperature changes without cracking.

FIG. 4c shows the channel 100 embedded within an asphalt footpath comprising an asphalt surface course 230, a binder course 232, a sub-base 234, and a formation level 236. The concrete haunch 210 is arranged within the sub-base 234 and the binder course 232 and is covered by the surface course 230, which is flush with the upper surface 116 of the channel 100.

FIG. 4d shows the channel 100 embedded within a paving slab footpath comprising paving slab surface course 240, a laying course 242, a sub-base 244 and a foundation level 246. The haunch 210 comprises a narrower upper portion which is flush with the upper surface 116 of the channel 100 and surrounding paving slabs 240, and a wider lower portion within the sub base 244 beneath the paving slabs 240.

FIG. 4e shows the channel 100 embedded within a block paving footpath comprising block paving surface course 250, a laying course 252, a sub-base 254 and a foundation level 256. The haunch 210 comprises a narrower upper portion which is flush with the upper surface 116 of the channel 100 and surrounding paving slabs 250, and a wider lower portion within the sub base 254 beneath the block paving 250.

In preferred embodiments, the channel 100 may be embedded across a pavement or sidewalk. FIG. 5 shows a side-on cross sectional view of the channel 100 embedded within a pavement surface 300 between a kerb 312 of a road 310 and an edge of a private garden 320.

The channel 100 is arranged within the pavement 300 such that an end of the channel is flush with the kerb 312, or with an indent or notch formed therein during the installation of the channel 110. The channel 100 is arranged flush with the surface of the pavement 300, which slopes downwards slightly towards the kerb 312. An open end 124 of the slot 120 of the channel 100 is arranged at this end of the channel to allow water to drain out of the slot 120 into the gutter of the road 310, and to allow an electric vehicle charging cable to extend out into said gutter when a vehicle on the road to be charged is not parked with its charging port exactly level with the channel 100.

The channel 100 and the concrete haunch 210 thereof are arranged above a plurality of utility pipes and channels 340 located beneath the pavement 300 in a two-meter utility zone extending from the edge of the kerb 312.

It will be appreciated that variation may be made to the above-described embodiments without departing from the scope of protection defined by the claims.

1. A channel comprising an elongate slot for receiving a length of a flexible conduit, wherein the slot comprises an opening extending along its length for laying a flexible conduit into the slot and for removing the flexible conduit therefrom and a barrier which is biased to block at least part of the opening in the absence of an externally applied force.

2. A channel according to claim 1 wherein the barrier is a resiliently deformable seal.

3. A channel according to claim 2 wherein the resiliently deformable seal is a brush.

4. A channel according to claim 1 wherein the barrier is biased towards blocking the majority of the length of the opening of the slot.

5. A channel according to claim 1 formed in an elongate body for embedding in ground surface.

6. A channel according to claim 5, wherein the body comprises one or more laterally protruding tabs.

7. A channel according to claim 5 wherein the slot extends to at least one end of the elongate body and an end of the slot is open at said end of the body.

8. A channel according to claim 5 wherein the opening of the slot is formed in a surface of the body which is a non-slip surface.

9. An arrangement comprising a channel according to claim 5 embedded within a ground surface.

10. An arrangement according to claim 9 wherein the ground surface is a pavement or sidewalk.

11. An arrangement according to claim 10 wherein a longitudinal end of the body of the channel is flush with a kerb of the pavement or sidewalk or with an indent formed in such a kerb.

12. An arrangement according to claim 9, wherein the slot comprises a base, which slopes from one end to another.

13. A method of constructing an arrangement according to claim 9, the method comprising embedding a channel formed in the elongate body within the ground surface, the channel comprising the elongate slot for receiving the length of the flexible conduit, wherein the slot comprises the opening extending along its length for laying the flexible conduit into the slot and for removing the flexible conduit therefrom and the barrier which is biased to block at least part of the opening in the absence of the externally applied force.

14. A method according to claim 13 comprising embedding the channel within the ground surface within or on a concrete haunch.
